(19) United States
(12) Patent Application Publication
(10) Pub. No.: US 2008/0250500 A1
(43) Pub. Date: Oct. 9, 2008

(54) Man-In-The-Middle Attack Detection in Wireless Networks

(75) Inventors: Timothy S. Olson, San Jose, CA (US); Arun Khanna, Sunnyvale, CA (US); Bruce McMurdo, San Jose, CA (US); Nancy Cam-Winget, Mountain View, CA (US); Liwen Wu, San Jose, CA (US)

Correspondence Address: Law Office of Mark J. Spolyar, 38 Fountain Street, San Francisco, CA, 94114, US

(73) Assignee: Cisco Technology, Inc., San Jose, CA (US)

(21) Appl. No.: 11/696,856

(22) Filed: Apr. 5, 2007

(51) Int. Cl. G06F 21/00

(52) U.S. Cl. 726/23; 726/22

(57) ABSTRACT

Detection of a man-in-the-middle attack. In particular implementations, a method includes detecting a first event comprising notification of an invalid wireless management frame operable to cause a termination of a connection between a wireless client and a wireless access point, wherein the notification is based on a failed verification of a management integrity code (MIC) appended to the wireless management frame. The method also includes detecting a second event involving notification of either an authentication failure associated with the wireless client or a connection between the wireless client and a rogue access point. The method also includes performing one or more actions upon detection of the first event and the second event within a threshold period of time of each other.

### TECHNICAL FIELD

This disclosure relates generally to wireless networks and security.

### BACKGROUND

Market adoption of wireless LAN (WLAN) technology has exploded, as users from a wide range of backgrounds and vertical industries have brought this technology into their homes, offices, and increasingly into the public air space. This inflection point has highlighted not only the limitations of earlier-generation systems, but also the changing role that WLAN technology now plays in people's work and lifestyles across the globe. Indeed, WLANs are rapidly changing from convenience networks to business-critical networks. Increasingly users are depending on WLANs to improve the timeliness and productivity of their communications and applications, and in doing so, require greater visibility, security, management, and performance from their network.

Unauthorized access to wireless networks is a growing security issue. Address spoofing is one method used to gain unauthorized access to a wireless network, or to launch denial of service attacks. For example, an impostor or malicious user may transmit messages to an authorized network element (e.g., wireless access point) using the Media Access Control (MAC) address of an authorized user. Similarly, an impostor network element may transmit messages to an authorized network element (e.g., wireless access point) using the MAC address of an authorized wireless access point. Until the IEEE 802.11 standards body completes a specification for protecting management frames, there will continue to exist systems that can not encrypt or authenticate 802.11 management frames. This makes it very easy for an attacker to spoof 802.11 management frames as if they are sent to or from a legitimate wireless client or wireless access point. Some solutions involve an overlay network that monitors the traffic in the air in an attempt to detect such attacks.

### DESCRIPTION OF THE DRAWINGS

FIG. 1 illustrates example components in a wireless local area network (WLAN) system.

FIG. 2 illustrates an example hierarchical wireless network including a central controller.

FIG. 3 illustrates an example hardware system, which may be used to implement a central controller.

FIG. 4 illustrates an example state machine for detecting man-in-the-middle attacks.

### DESCRIPTION OF EXAMPLE EMBODIMENTS

### A. Overview

Particular implementations facilitate detection of active man-in-the-middle attacks in wireless network environments including protection of wireless management frames. Protection of wireless management frames involves the use of message integrity checks (MICs) appended to wireless management frames. A recipient, such as a wireless access point or a wireless client, can validate the MIC before processing the wireless management frame. Generally, the MICs are generated using cryptographic keys. Replay protection mechanisms, such as counters and time stamps, may also be used. Accordingly, with knowledge of the cryptographic key, a recipient (such as a wireless client or a detector node) can validate the MIC and thus the wireless management frame. According to one implementation, a central controller, or other network device, determines if a possible attack has occurred, or is occurring, by correlating events associated with the same wireless client and that have occurred within a threshold time period. Such events are detected by one or more wireless access points of the wireless network infrastructure. In one implementation, the first event may be an invalid attempt to disconnect a particular wireless cheat from the wireless network. For example, a wireless access point may detect an invalid management frame, such as an invalid deauthentication frame or invalid disassociation frame transmitted to a given wireless client. In one implementation, a management frame may be invalid if it contains an invalid management integrity code (MIC), or if the management frame has no MIC. In one implementation, the second event may be a failed attempt to reconnect to the wireless network, such as an authentication failure (e.g., a reauthentication failure). If the two events involve the same wireless cheat and occur within a threshold time period, the two events are probably a result of an attempted man-in-the-middle attack. In other words, an attacker may have caused the wireless client to lose connection with the wireless network, and the attacker may be attempting to connect with the wireless network by spoofing the legitimate wireless client. As described in more detail below, in one implementation, a wireless intrusion detection system (WIDS) module utilizes a state machine where in each state of the state machine, each event (e.g., invalid wireless management frames) triggers the central controller to perform one or more actions (e.g., reset a timer) and to transition to another state, in particular implementations, the WIDS module may reside in a central controller, switch or any suitable network node. In one implementation, instead of a reauthentication failure, the second event may be detection of a legitimate wireless client roaming to a rogue access point. As such, the first event (e.g., an invalid deauthentication or invalid disassociation) correlating with this second event (e.g., a roam to a rogue access point) relative to the same wireless client within a threshold time period, could also indicate a man-in-the-middle attack.

### B. Example Wireless Network System Architecture

B.1. Network. Topology

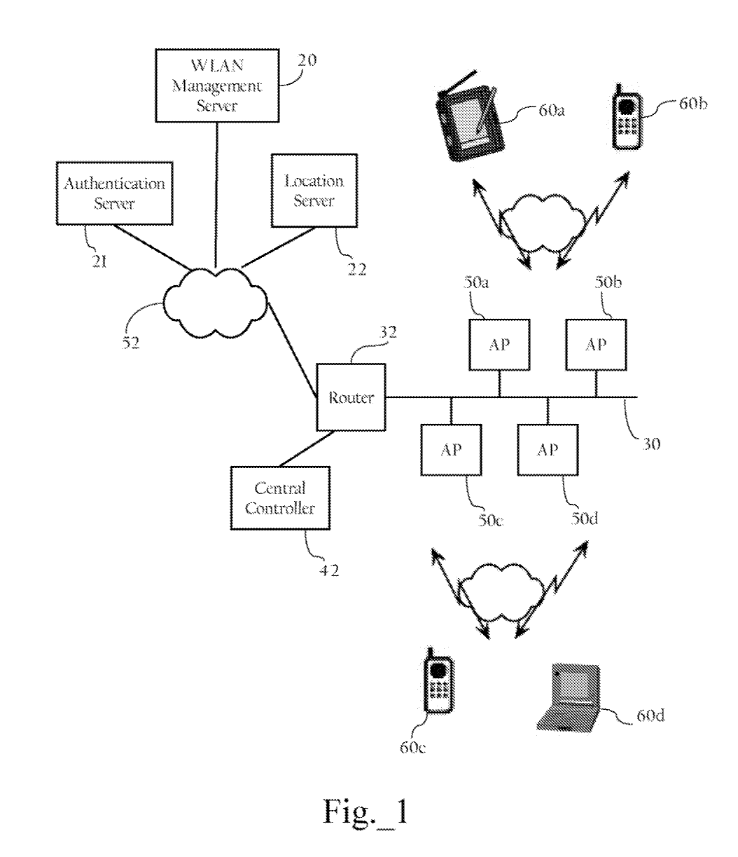

FIG. 1 illustrates example components in a wireless local area network (WLAN) system. In a specific embodiment of the present invention, the system includes a WLAN management server 20, an Authentication Authorization and Account (AAA) server 21, location server 22, and a central controller 24, a local area network (LAN) 30, a router 32, and wireless access points 50a, 50b, 50c, and 50d. LAN 30 is implemented by a switch (or an array of switches) and/or other network devices, such as a bridge.

As FIG. 1 illustrates, these network elements are operably connected to a network 52. Network 52, in one implementation, generally refers to a computer network, such as a LAN, a WAN, etc., that includes one or more intermediate network devices (e.g., routers, switches, etc.), which allow for the transmission of messages between WLAN management server 20 and wireless clients via wireless access points 50. Of course, network 52 can include a variety of network segments, transmission technologies and components, such as terrestrial WAN links, satellite links, optical fiber links, and cellular links. Network 52 could also be a campus LAN. LAN 30 may be a LAN, LAN segments implemented by an Ethernet switch (not shown), or an array of switches having multiple ports to which wireless access points 50 are connected. The wireless access points 50 are typically connected to switch ports via Ethernet links; however, other link layer connection protocols or communication means can be employed. FIG. 1 illustrates one possible network environment in which the invention may operate; however, other implementations are possible. For example, although WLAN management server 20 is illustrated as being on a different LAN or LAN segment, it may be co-located with wireless access points 50.

The wireless access points 50 are operative to wirelessly communicate with remote wireless client devices 60a, 60b, 60c, and 60d. In one implementation, the wireless access points 50 implement the wireless network protocol specified in the IEEE 802.11 WLAN specification; of course, other wireless network protocols may be used. The wireless access points 50 may be autonomous or so-called “fat” wireless access points or light-weight wireless access points operating in connection with a wireless switch (not illustrated). In addition, the network infrastructure may also include a Wireless LAN Solution Engine (WLSE) offered by Cisco Systems, Inc. of San Jose, Calif. or another wireless network management system. In some implementations, the network infrastructure may also include one or more Wireless Control System (WCS) nodes operative to manage one or more wireless switches and access points.

B.2. Central Controller

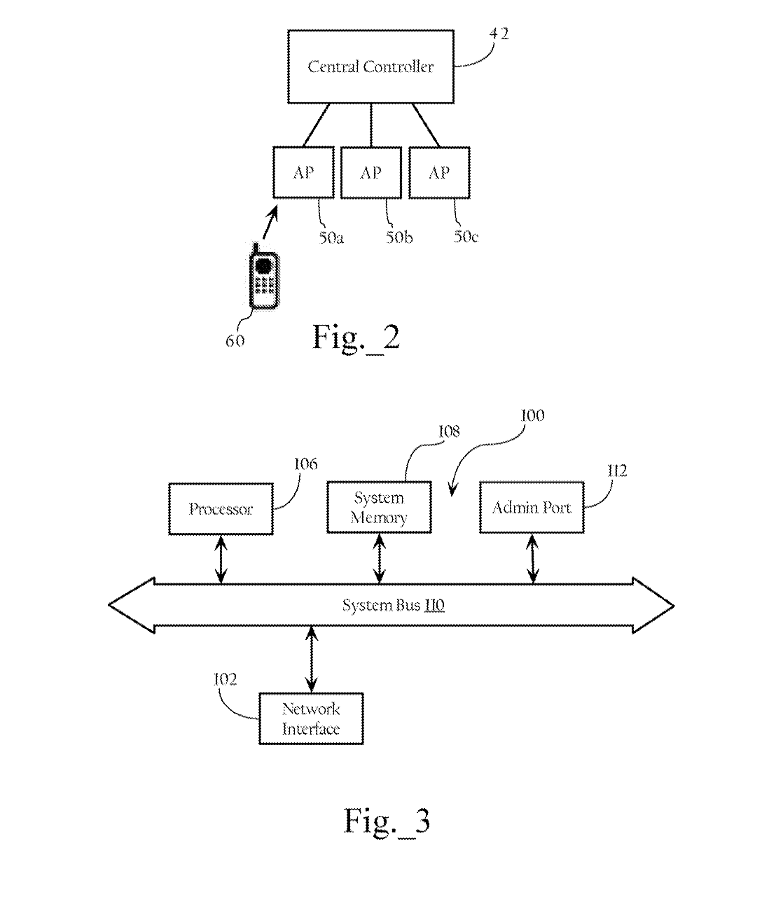

FIG. 2 illustrates an example hierarchical wireless network including a central controller 42 according to one implementation of the present invention. In one implementation, the central controller 42 may be implemented as a wireless domain server (WDS) or, alternatively, as a wireless switch. If the central controller 42 is implemented with a WDS, the central controller 42 is operative to communicate with autonomous or so-called “fat” wireless access points. If the central controller 42 is implemented as a wireless switch, the central controller 42 is operative to communicate with light-weight wireless access points and process wireless protocol and network management information. As FIG. 2 illustrates, a central controller 42 may he directly connected to one or more access points 50. Alternatively, a central controller 42 may be operably connected to one or more access points over a switched and/or routed network environment, as FIG. 1A illustrates.

FIG. 3 illustrates an example hardware system 100, which may be used to implement a controller 42. As FIG. 3 shows, in one implementation, the central controller 42 includes a network interface 102. Central controller 42, in one implementation, further comprises a processor 106, a memory 108, one or more software modules stored in memory 108, including instructions for performing the functions described herein, and a system bus 110 operably connecting these components. The central control elements may optionally include an administrative port 112 allowing for administrative access for such purposes as configuration and diagnostic access.

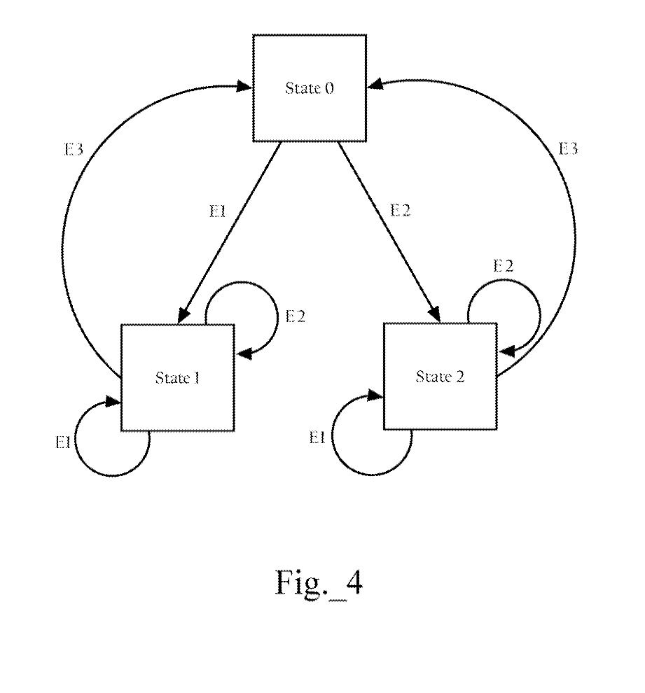

As described in more detail below in connection with FIG. 4, the central controller 42 includes a state that may be used to implement one or more aspects of the functionality described herein for detecting man-in-the-middle attacks. That is, a wireless intrusion detection system (WIDS) module used for the event correlation and detection of man-in-the-middle attacks is included in the central controller. Note that the WIDS may reside in the central controller or any other device that communicates with wireless access points or processing and managing such events.

B.3. Infrastructure Management Frame Protection

In particular implementations, a wireless domain server or a central control element (e.g., WLAN management server 20, authentication server 21, central controller 42, etc.) may be suitably adapted to function as security server with the capability to perform the authentication itself or be coupled to a security server, or authentication server, such as a RADIUS server (not shown), for performing these functions.

In one implementation, when a given wireless access point (e.g., wireless access point 50a) receives a management frame sent by another wireless access point (e.g., wireless access point 50b), the receiving wireless access point 50a obtains a key for the sending wireless access point 50b. In one implementation, the wireless access point 50a may send a message to the security server requesting the key for wireless access point 50b. Alternatively, in one implementation, wireless access point 50b, upon being authenticated by security server may send the key to neighboring access points, such as wireless access point 50a. The management frame is then validated by wireless access point 50a using the key for wireless access point 50b.

In particular implementations, management frames, such as those used for an 802.11 network, may include but are not limited to beacons, probe requests, probe responses, association responses, de-authentication requests, disassociation requests, reassociation requests, 802.11 Task Group E (TGe) action frames, 802.11 Task Group h (TGh) action frames, and 802.11 Task Group k (TGk) action frames.

In one implementation, the management frame may contain an information element (IE), for example an MFP IE, which provides at least a sequence number, a timestamp and a message integrity check (MIC). In particular implementations, an MFP IE may include a management frame protection identification (MFP ID) that indicates that the IE is an MFP IE. The MFP IE may also include a length field that stores the length of the MFP IE, and may include a timestamp field for storing a timestamp. In one implementation, the timestamp in the timestamp field may be employed for detecting a rogue access point. For example, if a rogue access point rebroadcasts a management frame, or broadcasts a management frame with a copied IE, the timestamp in timestamp field would indicate that the frame is an old frame, facilitating the detection of a spoofed or otherwise invalid management frame.

In particular implementations, the MFP IE may also include a replay protection counter that may be used to store a sequential number to help detect spoofed or otherwise invalid management frames by comparing the sequential number stored in the replay protection counter with the sequential number obtained from previously received packets. If the MFP IE in a management frame is determined to have the same or lower sequential number as an earlier MFP IE, then a spoofed or otherwise invalid frame would be indicated.

In one implementation, the MFP IE may also include a MIC field that stores a message integrity check (MIC). The inability to validate the data stored in the MIC field using the key for the purported source of the management frame would be indicative of a spoofed or otherwise modified frame. For example, when a wireless access point 50b sends a management frame (e.g., a probe response), wireless access point 50a receives the management frame and uses a key that was either obtained from wireless access point 50b via the network or directly from the security server and validates the management frame using the key. The key may decode the MFP IE to validate the data in the MIC field. In implementations employing a timestamp and/or sequence counter, wireless access point 50a may verify that the timestamp stored in the timestamp field is not stale, and/or that the sequence number stored in replay protection counter is not the same as, or lower than, a sequence number received in a previous packet. If wireless access point 50a detects an invalid MIC, timestamp, and/or replay protection counter, wireless access point 50a may generate an alarm. In particular implementations, the alarm may be suitably in the form of a visual, audio, and/or an automatic notification, such as an email to a system administrator

In a specific example, assume there is a rogue access point (e.g., wireless access point 50c) attempting to pretend to be wireless access point 50b. The rogue access point 50c may send a management frame, such as a deauthenticate or disassociate message to a client 60 that is associated with wireless access point 50b. If the rogue access point 50c sends a deauthenticate or disassociate message to the client 60, this has the potential effect of causing client 60 to roam to rogue access point 50c. Wireless access point 50a, which is in range of rogue access point 50c and is capable of receiving signals sent by rogue access point 50c, also receives the management frame sent by rogue access point 50c. Wireless access point 50a would then attempt to verify the management frame using the key supplied either by wireless access point 50b or the security server. If the message sent by rogue access point 50c does not have a signature, then wireless access point 50a determines that the management frame is invalid (e.g., was sent by an intruder). If the message does have a signature, e.g., an MFP IE, then wireless access point 50a attempts to verify the MIC associated with the message using the key for wireless access point 50b. If the MIC cannot be validated with the key for wireless access point 50b, then wireless access point 50a determines that, the message is invalid (e.g., spoofed or sent by a rogue AP). In addition, if the management frame contains a sequence number or timestamp, these may also be verified by wireless access point 50a.

As wireless access point 50a detects invalid management frames, wireless access point 50a may generate an alarm. In particular implementations, the alarm may be at least one of an email to a system administrator (not shown), an auto-dialed message to a system administrator, an alert sent to the security server, and/or an audible or visual alarm.

In particular implementations, the security server may implement a method for distributing signature keys between wireless access points of the network. It should be noted that a key established as part of the wireless access point to security server authentication sequence may then be used to secure the key distribution sequence. For example, if the wireless access point 50b authenticates with one or more security servers. The security server may assign a first signature key to wireless access point 50b. Optionally, the security server may assign a second signature key to wireless access point 50a. The security server in response to a request from wireless access point 50a for the signature key for wireless access point 50b may send the first signature key to wireless access point 50a enabling it to validate messages purported to be originating from wireless access point 50b. Other implementations may further contemplate that the security server may store a list of wireless access points requesting the signature key for wireless access point 50b. When the security server updates the signature key of wireless access point 50b, the security server may automatically notify wireless access point 50a and, optionally, propagate the updated signature key to any other wireless access point that previously requested wireless access point's 50b signature key of the update. In implementations that have wireless access point 50b distributing the signature key, wireless access point 50b may automatically propagate the updated signature key to access points previously requesting the signature key.

### C. State Machine for Detecting Man-in-the-Middle Attacks

As describe above, the wireless network infrastructure can detect when a management frame is being spoofed or has an invalid MIC. In particular implementations, the wireless client might not be MFP protected. In other words, the wireless client is not actively participating in MFP and does not know that the management frames should be protected, or how to validate them.

A typical man-in-the-middle-attack involves an attacker first deauthenticating or disassociating a wireless client and then redirecting that wireless client to a dummy access point. This is accomplished by the attacker spoofing a management frame as if the management frame were coming from a legitimate wireless access point. The attacker can then hijack the other end of an already established link (e.g., (re)authenticate) and attempt to compromise the security of that session.

As described in more detail below, a spoofed management frame (invalid deauthentication/disassociation) can be detected using MFP. In one implementation, such an event may be recorded in an Intrusion Detection System (IDS) state machine. In one implementation, the WIDS module in the central controller 42 monitors for one of two subsequent events: a reauthentication or failed authentication, or detection of the legitimate client on a rogue access point while frames continue to be sent on the existing connection. In one implementation, a wireless access point may also perform the monitoring. In one example, the attacker is attempting to retrigger authentication to possibly discover keys or downgrade authentication. In another example, the WIDS module determines that a given wireless client appears to be connected to two wireless access points at once (e.g., the original access point and a rogue access point).

The following examples assume that one wireless access point (e.g., wireless access point 50b) detects an attempted spoof of another wireless access point (e.g., wireless access point 50a). Still further, one implementation can be configured to detect possible man-in-the-middle attacks in connection with encrypted 802.1x sessions. Other implementations of the invention can be configured to detect possible man-in-the-middle attacks in connection with open or unencrypted sessions.

C.1. Encrypted Connections Using dot1x Authentication Sessions

The following example applies to wireless networks involving encrypted connections using dot1x authentication sessions. Such sessions may apply to wireless networks involving, for example, enterprise deployment of a wireless network.

FIG. 4 illustrates an example state machine for detecting man-in-the-middle attacks. As described in more detail below, at each state of the state machine, each event triggers the WIDS module to perform one or more actions and to transition the state machine to another state.

C.1.a. State 0 (Initial State)

Referring to FIG. 4, State 0 is an initial state (starting point) of the state machine, where transition events have not yet been detected. In one implementation, a first event may be the detection of an invalid management frame such as an invalid deauthentication or invalid disassociation that is directed to terminating a wireless connection. The wireless access point may detect such invalid deauthentication or invalid disassociation frames using MFP functionalities. In one implementation, a management frame may be invalid if it is not MFP protected (e.g., it not protected with a MIC). In other words, if there is no MIC. In one implementation, a management frame may be invalid if it has an invalid MIC. Another event type may include failed MICs on 802.11e or Quality of Service management frames that are spoofed and that may cause a wireless client to terminate the connection or to roam.

In one implementation, the wireless access point (e.g., wireless access point 50a) that detected the invalid deauthentication or invalid disassociation generates the MFP notification and sends the MFP notification to the WIDS module. In one implementation, the MFP notification identifies the wireless client that experienced the invalid deauthentication or invalid disassociation by the MAC address of the wireless client. In one implementation, the MFP notification also indicates the basic service set identifier (BSSID) of the wireless access point identified in the invalid frame. In one implementation, after the WIDS module receives the MFP notification, the WIDS module generates a “correlation record” for each wireless client associated with the BSSID in the notification and starts a timer for each correlation record. In one implementation, if more than one wireless access point (e.g., wireless access points 50b and 50c) detects an invalid deauthentication or invalid disassociation at another wireless access point (e.g., wireless access point 50a) involving a different BSSID, the WIDS module may generate multiple correlation records, one for each detection of an invalid management frame. As FIG. 4 illustrates, detection of an invalid management frame causes the central controller 42 to transition from State 0 to State 1.

In one implementation, a second event may be a reauthentication failure (E2). In one implementation, after the WIDS module receives a notification of a reauthentication failure from a wireless access point, the central controller 42 generates a “correlation record” for the wireless client that experienced the reauthentication failure, and the WIDS module starts a timer for the correlation record. The central controller 42 then transitions the state machine from State 0 to State 2.

C.1.b. State 1 (Invalid Disconnect)

In one implementation, while in State 1, if the central controller 42 receives a notification of invalid deauthentication or invalid disassociation frame, the central controller 42 restarts a timer (E1). In one implementation, while in State 1, the occurrence of the second event (E2) (e.g., a reauthentication failure) triggers implementation of one or more policies, such as a notification policy. At this point, the reauthentication failure associated with a particular wireless client may correlate with the invalid deauthentication or invalid disassociation frame associated with the same wireless client. In one implementation, if there is a correlation, a man-in-the-middle attack may be active, and the WIDS module may apply a notification policy. In one implementation, the notification policy may involve the WIDS module notifying the nodes of the wireless network infrastructure (e.g., the wireless access points) of the attack. In another implementation, a notification message or alert may be transmitted to a network management system; or both a notification message or alert is sent to both the wireless network and the network management system.

In one implementation, if there is a time out (E3) by which no correlated events such as E2 occurs, the WIDS module deletes the correlation records. The WIDS module then transitions the state machine from State 1 back to State 0.

C.1.c. State 2 (Failed Reconnect)

In one implementation, while in State 2, the occurrence of an invalid deauthentication or invalid disassociation frame (E1) triggers a notification policy. At this point, the invalid deauthentication or invalid disassociation frame of the wireless client may correlate with the reauthentication failure associated with a same wireless client. In one implementation, if there is a correlation, a man-in-the-middle attach may be active, and the WIDS module may apply a notification policy.

In one implementation, while in State 2, if an authentication failure is detected as to a wireless client identified in a correlation record, the WIDS module restarts a timer (E2) and remains in State 2.

In one implementation, while in State 2, if there is a time out (E3) where no such second event (E2) occurs, the WIDS module deletes the correlation record. The WIDS module then transitions the state machine from State 2 hack to State 0.

C.2. Open-Access Authentication Sessions

The following example can be applied to wireless networks involving open-system authentication sessions. Such sessions apply to wireless networks involving, for example, public deployment, or guess access for a wireless network. In particular implementations, the detection of attacks is similar to the description above, where a second event (E2) is correlated with a first event (E1) involving an invalid deauthentication or invalid disassociation frame. The difference is that instead of detecting a reauthentication failure, the second event (E2) is a wireless client becoming a client of a rogue access point. In other words, the state diagram of FIG. 4 applies to tins embodiment except that the second event is an association between a wireless client of an infrastructure access point and a rogue access point. In one implementation, the WIDS module may access a table of rogue wireless points to identify them.

The present invention has been explained with reference to specific embodiments. For example, while embodiments of the present invention have been described as operating in connection with IEEE 802.11 networks, the present invention can be used in connection with any suitable wireless network environment. Other embodiments will be evident to those of ordinary skill in the art. It is therefore not intended that the present invention be limited, except as indicated by the appended claims.

What is claimed is:

1. Logic encoded in one or more tangible media for execution and when executed operable to:
detect a first event comprising notification of an invalid wireless management frame operable to cause a termination of a connection between a wireless client and a wireless access point, wherein the notification is based on a failed verification of a management integrity code (MIC) appended to the wireless management frame;
detect a second event involving notification of either an authentication failure associated with the wireless client or a connection between the wireless client and a rogue access point; and
perform one or more actions upon detection of the first event and the second event within a threshold period of time of each other.

2. The logic of claim 1 wherein the first event is a detection of an invalid deauthentication frame or an invalid disassociation frame.

3. The logic of claim 1 wherein the invalid wireless management frame is invalid because there is no MIC.

4. The logic of claim 1 wherein the invalid wireless management frame is invalid because the MIC is invalid.

5. The logic of claim 1 wherein the logic is further operable to generate a correlation record for each instance of the first event and a correlation record for each instance of the second event.

6. The logic of claim 1 wherein the logic is further operable to:
generate a correlation record for each instance of the first event;
start a timer for a given instance of the first event; and
restart the timer for new instances of the first event to determine if there may be other wireless clients experiencing the first event.

7. The logic of claim 1 wherein the logic is further operable to:
generate a correlation record for each instance of the second event;
start a timer for a given instance of the second event; and
restart the timer for new instances of the first event to determine if there may be another attempt to reauthenticate.

8. The logic of claim 1 wherein the logic is further operable to conditionally notify one or more wireless access points based on the correlation between the first event and the second event.

9. The logic of claim 1 wherein the logic is further operable to conditionally notify a management server based on the correlation between the first event and the second event.

10. The logic of claim 1 wherein the logic is further operable to conditionally notify a security server based on the correlation between the first event and the second event.

11. A method comprising:
detecting a first event comprising notification of an invalid wireless management frame operable to cause a termination of a connection between a wireless client and a wireless access point, wherein the notification is based on a failed verification of a management integrity code (MIC) appended to the wireless management frame;
detect a second event involving notification of either an authentication failure associated with the wireless client or a connection between the wireless client and a rogue access point; and
performing one or more actions upon detection of the first event and the second event within a threshold period of time of each other.

12. The method of claim 11 wherein the first event is a detection of an invalid deauthentication frame or an invalid disassociation frame.

13. The method of claim 11 wherein the invalid wireless management frame is invalid because there is no MIC.

14. The method of claim 11 wherein the invalid wireless management frame is invalid because the MIC is invalid.

15. The method of claim 11 further comprising generating a correlation record for each instance of the first event and a correlation record for each instance of the second event.

16. The method of claim 11 further comprising:
generating a correlation record for each instance of the first event;
starting a timer for a given instance of the first event; and
restarting the timer for new instances of the first event to determine if there may be other wireless clients experiencing the first event.

17. The method of claim 11 further comprising:
generating a correlation record for each instance of the second event;
starting a timer for a given instance of the second event; and
restarting the timer for new instances of the first event to determine if there may be another attempt to reauthenticate.

18. The method of claim 11 further comprising conditionally notifying one or more wireless access points based on the correlation between the first event and the second event.

19. The method of claim 11 further comprising conditionally notifying a management server based on the correlation between the first event and the second event.

20. The method of claim 11 further comprising conditionally notifying a security server based on the correlation between the first event and the second event.

21. A system comprising:
one or more wireless access points configured to validate detected management frames by verifying a message integrity code (MIC); and
wireless intrusion detection system (WIDS) module operable to detect a first event comprising notification of an invalid wireless management frame operable to cause a termination of a connection between a wireless client and a wireless access point, wherein the notification is based on a failed verification of a management integrity code (MIC) appended to the wireless management frame; detect a second event involving notification of either an authentication failure associated with the wireless client or a connection between the wireless client and a rogue access point; and perform one or more actions upon detection of the first event and the second event within a threshold period of time of each other.

22. The system of claim 21 wherein the first event is a detection of an invalid deauthentication frame or an invalid disassociation frame.

23. The system of claim 21 wherein the invalid wireless management frame is invalid because there is no MIC.

24. The system of claim 21 wherein the invalid wireless management frame is invalid because the MIC is invalid.

25. The system of claim 21 wherein the WIDS module is further operable to generate a correlation record for each instance of the first event and a correlation record for each instance of the second event.

26. The system of claim 21 wherein the WIDS module is further operable to:
generate a correlation record for each instance of the first event;
start a timer for a given instance of the first event; and
restart the timer for new instances of the first event to determine if there may be other wireless clients experiencing the first event.

27. The system of claim 21 wherein the WIDS module is further operable to:
generate a correlation record for each instance of the second event;
start a timer for a given instance of the second event; and
restart the timer for new instances of the first event to determine if there may be another attempt to reauthenticate.

28. The system of claim 21 wherein the WIDS module is further operable to conditionally notify one or more wireless access points based on the correlation between the first event and the second event.

29. The system of claim 21 wherein the WIDS module is further operable to conditionally notify a management server based on the correlation between the first event and the second event.

30. The system of claim 21 wherein the WIDS module is further operable to conditionally notify a security server based on the correlation between the first event and the second event.
